(19) United States
(12) Patent Application Publication
(10) Pub. No.: US 2012/0310666 A1
(43) Pub. Date: Dec. 6, 2012

(54) PERSONALIZED MEDICAL RECORD

(75) Inventors: BEILEI XU, PENFIELD, NY (US); STUART A. SCHWEID, PITTSFORD, NY (US); ROBERT P. LOCE, WEBSTER, NY (US); LEE ANNE WILLIAMS, PITTSFORD, NY (US)

(73) Assignee: Xerox Corporation, Norwalk, CT (US)

(21) Appl. No.: 13/150,462

(22) Filed: Jun. 1, 2011

(51) Int. Cl. G06Q 50/00

(52) U.S. Cl. 705/3

(57) ABSTRACT

The present disclosure provides a method of producing a personalized medical record, comprising: incorporating at least a portion of a prerecorded stock tutorial video having stock information and one or more uncompleted segments for inserting personalized medical information onto a single recording medium. The personalized medical information can include personalized health information including vital health statistics. The method combines the at least a portion of the prerecorded stock tutorial video including the stock information on a variety of medical maladies with the personalized medical information. The stock tutorial video can include at least one predeterminable insertion point within the uncompleted segments for inserting the personalized medical information. The method further provides the personalized medical information at the at least one predeterminable insertion point for merging with the at least a portion of the prerecorded stock tutorial video for producing at least a portion of the personalized medical record.

### CROSS REFERENCE TO RELATED PATENTS AND APPLICATIONS

U.S. patent application Ser. No. ______, filed Jun. 1, 2011, entitled “PERSONALIZED MEDICAL RECORD,” by Xu et al. is incorporated herein by reference in its entirety.

### BACKGROUND

The present disclosure pertains generally to methods for creating electronic personalized multimedia files, and more specifically to creating a personalized health related (i.e. medical) record and electronic file incorporating user-supplied digital images, information, health data, and video combined with stock video footage and/or synchronized further with audio recordings. The personalized record informs and educates the patient along with other health care professionals.

It is expensive to provide standard health care information via personal interaction with a healthcare professional. Many videos exist that describe all types of maladies and treatments. On the other hand, the details of a given patient's specific condition and treatment will not be provided nor adequately conveyed in a standard video. Also, important details from a discussion with a healthcare professional may not be well understood, not accurately remembered nor accurately shared with other interested parties. What is needed is a cost effective method to provide general and specific healthcare information that a patient can view multiple times and share with concerned parties.

Medical videos currently in the public domain are typically standard tutorials. Personalized videos described in the public domain concern other applications. For example, production of personalized video stories can include unfinished stories that are first recorded on a video medium with blank segments. Digital sequences can be used to complete the segments, for example, by portraying a character with a keyed-out facial area, and then using the digitized image of a subject to complete the character. A plurality of different stories may be prerecorded, each substantially completed but including a plurality of unfinished segments. The stories may include animation, for example in the form of cartoons, with personalizing components being recorded onto the previously uncompleted file or tape in such a way that a smooth, visual transition is realized at the start and ending of each segment.

Other applications can include a personalized system that combines user-supplied data and digital visual images or stored archival stock video footage and popular music works of the last century to generate a personalized life story documentary movie. The personalized system gathers input from the user, such as age, gender, and allows the user to upload personal digital images, video, and other electronic files. The user inputs dates of each image or video uploaded so that the personalized video system can chronologically order the items. The personalized system can combine the user-supplied information and digital media with archived stock video and/or audio footage of significant events and famous personalities to place the recipient's life story in historical context. The personalized system can also provide a music soundtrack and synchronizes the display of the digital media and archived footage to the selected soundtrack. One embodiment allows the user to upload birth certificates, marriage certificates, newspaper clippings or other digitally scanned material for use in the system. Another embodiment allows the user to record or upload a voiceover narrative, sound effects or other audio content.

In still another application, a system can be deployed at a theme park for capturing and managing personalized video images, e.g., for creating personalized video products for patrons at the theme park. The system includes an RFID system to track patron movements around the park, a camera system to capture video images at designated locations around the park, a computer-based video content collection system to collect and store personalized video clips of patrons, and a video product (e.g., DVD) creation and point of sale system to create the end product for sale to the patron.

What is needed is a cost-effective method to provide general and specific healthcare information that a patient can (on demand) update, maintain, review, access and/or share remotely with concerned parties. The disclosure below describes a method for personalizing medical record information directed toward a particular individual's healthcare history that has different properties than the personalized video that has been previously disclosed.

### SUMMARY

The present disclosure provides a method of producing a personalized medical record, comprising: incorporating at least a portion of a prerecorded stock tutorial video having stock information and one or more uncompleted segments for inserting personalized medical information onto a single recording medium. The personalized medical information includes personalized health information including vital health statistics. The method further comprises combining the at least a portion of the prerecorded stock tutorial video including the stock information on a variety of medical maladies with the personalized medical information. The stock tutorial video includes at least one predeterminable insertion point within the uncompleted segments for inserting the personalized medical information. The method still further comprises providing the personalized medical information at the at least one predeterminable insertion point for merging with the at least a portion of the prerecorded stock tutorial video for producing at least a portion of the personalized medical record.

The present disclosure further provides a method of producing a personalized medical record, comprising: incorporating at least a portion of a prerecorded stock tutorial video having stock information and one or more uncompleted segments for inserting personalized medical information onto a single recording medium, and combining the at least a portion of the prerecorded stock tutorial video including the stock information on a variety of medical maladies with the personalized medical information. The stock tutorial video includes at least one predeterminable insertion point within the uncompleted segments for inserting the personalized medical information. The method further comprises providing the personalized medical information at the at least one predeterminable insertion point for merging with the personalized medical record; wherein providing the personalized medical information includes providing a sequence of information selected from the group consisting of a recording of a discussion with a health practitioner, inserting components from a video scripting language, and inserting graphical and textural image annotations. Providing the personalized medical information is selected using a graphical user interface (GUI) for inserting information selected from the group consisting of personalized audio, video, pictorial, and textual data.

As further described herein, the term personalized electronic record or file refers to a personalized health related story, i.e. medical record, video story, and/or history.

### BRIEF DESCRIPTION OF THE DRAWINGS

FIG. 1 shows, in highly schematic form, an outline of a personalized video tutorial for an individual and an associated malady;

FIG. 2 is a drawing which illustrates a range of motion, namely, a comparison of current range of motion to a normal range of motion (and/or historical range of motion);

FIG. 3 depicts a side by side historical x-ray comparison (i.e. x-rays taken at two different time periods) showing a patient's bone joint degeneration over time;

FIG. 4 is an exemplary graph displaying one patient's personalized medical history showing a trend of a vital sign;

FIG. 5 provides an exemplary listing of annotations associated with an image, graph, or video for organizing a personalized medical record;

FIG. 6 provides another listing of annotations associated with modifying a personalized medical record;

FIG. 7 provides an exemplary listing of treatments, options and/or recommendations for an individual and his/her associated malady; and,

FIG. 8 provides still another listing of annotations associated with modifying a personalized medical record (i.e. for a specific malady) through a GUI.

### DETAILED DESCRIPTION

To be described in more detail hereinafter, the present disclosure provides a personalized medical record/electronic file 100, and method to produce the record/video, that combines stock tutorial medical record/video information with personalized information and/or maladies for a specific patient. Personalized information can include patient identification, inserted, overlaid, or parameterized information (still images, video, audio, text or graphics, etc.), historical sequence of images, differences from normal or previous states (range of motion, shape, size, texture, etc.), and instructions for therapy and/or treatment.

The present disclosure provides hardware apparatus, medical video stories, and methods whereby a pre-recorded stock video may be personalized by combining live or digitally captured images to segments of the pre-recorded stock video. In addition to personalized imagery, the system, which will subsequently be described in detail, is adaptable to the inclusion of personalized health information, diagnostics, and/or treatments. The system is additionally capable of including captioning such as an individual's name 105 or other information as part of the personalization of the underlying medical record.

There are several ways in which the personalized medical record 100 can be created. One could start with a standard stock video, prerecording, or medical record information 110. Stock or ‘canned’ videos 110 can be created in a manner that readily allows personalization, such as fixed or predeterminable insertion points between frames and within frames. The frames can allow for video, pictorial, textual, textural, and audio insertion. For example, blank areas can represent ‘blank canvas’ portions of the video or frames where information may be inserted. There can be known portions of the video or frames where movement or other features can be varied, augmented, personalized, and/or edited, etc. There can be a graphical user interface (GUI) that prompts (and enables) a practitioner to insert information in order to, for example, modify ranges, sizes, or qualities of a feature. The personalized medical record/video 100 can be partially created using recorded information from a discussion with a practitioner and all other medical professionals encountered. The personalized medical electronic record/video can also be facilitated, for example, using components from a video scripting language such as AVISynth, where the script can be either written directly or can be constructed from prompts as a GUI input or a query interface. The video can also be created using video editing software, such as Adobe After Effects, or Microsoft Movie Maker.

Many prerecorded videos exist that describe all types of maladies and treatments that could be used to convey standard information for crafting the electronic personalized medical record. Albeit, the details of a given patient's specific condition and treatment will not be provided in a standard file or video and must be conveyed in some personalized manner. In many instances, medical information can be too sophisticated and detailed for a patient to fully understand from a one-time discussion, especially if they lack a relevant background or are under the stress of their condition or treatment. Details may not be accurately remembered, nor accurately or timely shared with other interested parties such as family members, other care takers, insurance providers, and legal parties. In other situations, lack of portability or accessibility prohibits sharing with interested parties.

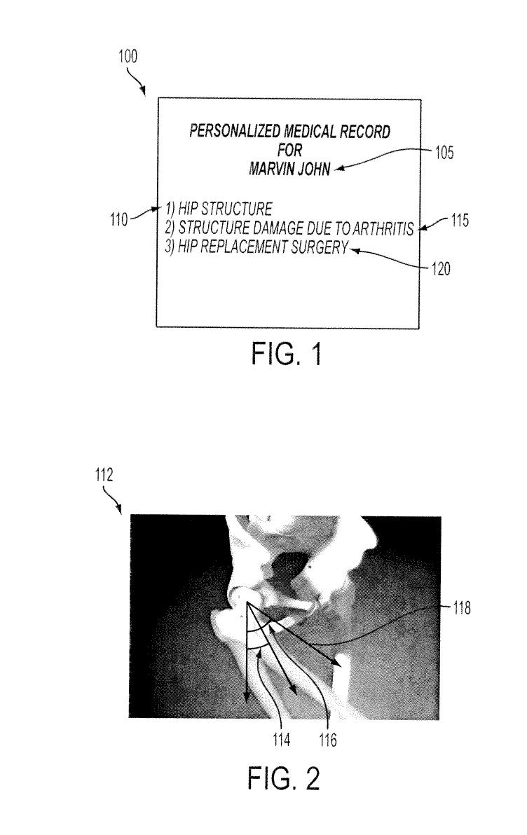

Referring to FIG. 1, the medical record, indicated generally at 100, includes a non-personalizable portion 110 having stock information related to particular health maladies that can be edited. Along with the non-personalizable portion 110 there are one or more personalized segments that can be edited such as that shown at 115, 120.

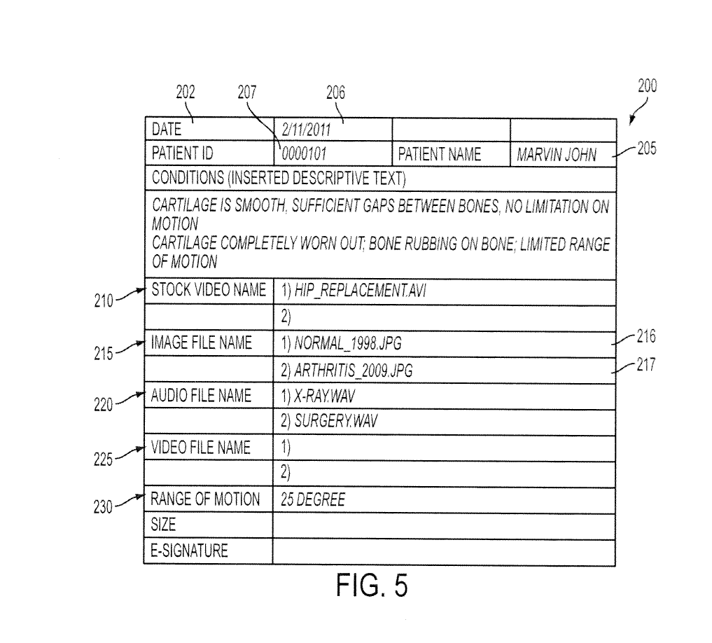

A video camera can be used to capture the image of the person or object to be used for personalization purposes. In the event that a flat image is to be used for such personalization, a camera may be replaced with another electronic device such as a scanner, graphical input device and so forth. The electronic capturing device can be interfaced to a central computer having a keyboard (not shown), the computer can be responsible for the various editing and control features necessary to carry out personalization associated with producing a final electronic record (FIGS. 5, 6, and 8). The keyboard can be customized or replaced with any type of input device, including a touch screen, voice input, etc.

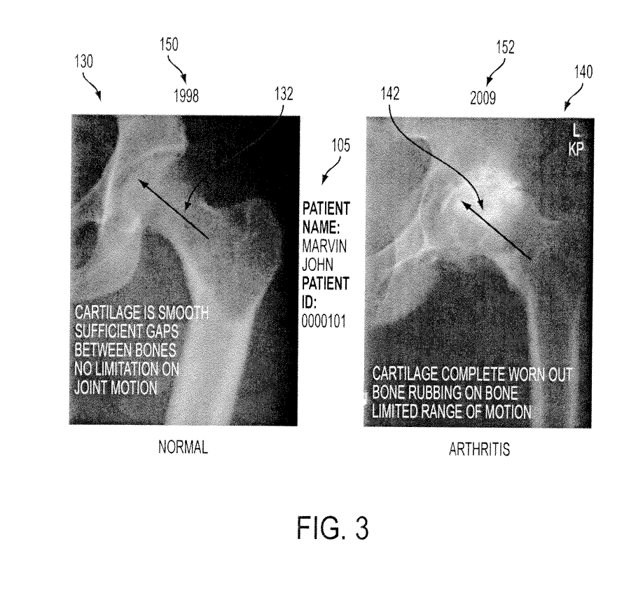

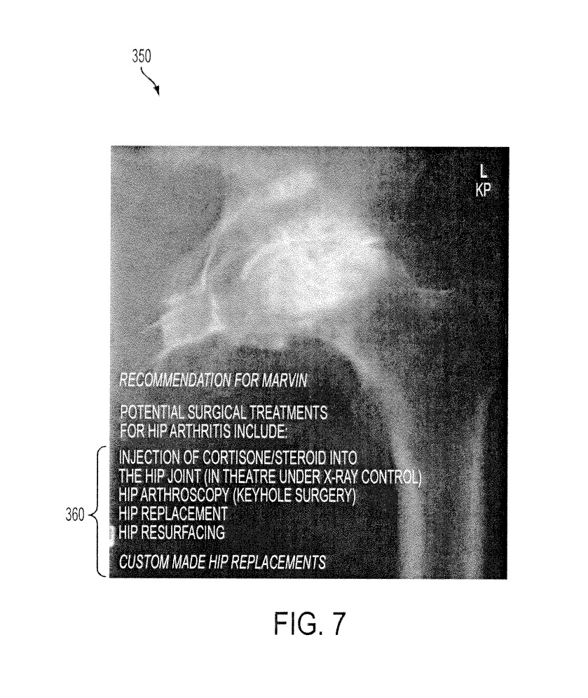

As outlined above, the present disclosure comprises a personalized electronic medical record/video 100, and method to produce the medical record/video, that combines stock prerecorded tutorial files 110 with information personalized for a specific patient along with an associated malady or history 115, 120. Personalized information can be inserted, overlaid, etc., and can include patient identification information 105, parameterized information (still images, video, audio, text or graphics, etc.), historical sequence of images (FIG. 3), differences from normal or previous states (range of motion, shape, size, texture, etc.) (FIG. 2), and/or instructions for therapy (FIG. 7). One could start with a standard stock video which has been prerecorded or created in a manner that readily allows personalization, such as fixed and/or predeterminable insertion points between frames and/or within frames. There can be “blank canvas” portions of the video, frames, or audio track where information may be inserted. The standard stock information 110 is downloaded into the personalized medical record 100 for editing. There can be known portions of the video frame sequence where movement or other features can be varied. There can be a GUI (FIGS. 5, 6 and 8) that prompts a practitioner to insert information or modify ranges, sizes, or qualities of a feature; and records audio and video information. The personalized file can be created and modified, for example, using recorded information from a discussion with a practitioner. The personalized medical record/video can be created from components using a video scripting language such AVISynth, where the script can be either written directly or constructed from prompts as a GUI input or a query interface. The record can also be created using video editing software, such as Adobe After Effects, or Microsoft Movie Maker.

The personalized information in the medical record can contain relevant identifications, which could include information such as patient's name 105, medical topic 115, date 106, preparer 107, responsible physicians/technicians, etc. FIG. 1 provides an example of the presentation of some of this information in a title slide format.

In one exemplary illustration, standard medical files 110 exist that show the operation of joints, such as a hip joint (FIG. 2). The range of motion 112 can be presented for both a normal joint and an abnormal joint (i.e. overlaid onto the video) for a particular person by parameterizing the motion in the stock video (e.g. degree of motion per frame). FIG. 2 shows exemplary ranges 114, 116, where the narrower angle 114 could be due to an arthritic condition which is then compared with a normal range of motion 116. FIG. 2 shows the narrower range of motion 114 with arrows and angles (textural annotations), while in a personalized video it could be shown dynamically by specifying and allowing a video segment showing the personal range of motion. Graphical overlays, such as arrows 118 can also be included to aid in visualizing the range. Another alternative is to present two embedded videos within the full video frame, one with a standard or normal range, and the other with a personalized range.

Medical images can be inserted as a comparison to a standard or viewed in a historical sequence. Referring to FIG. 3, an x-ray of a healthy hip 130 may be shown next to a person-specific arthritic hip 140 so that the cartilage and joint degeneration 142 can be compared to normal 132 and better understood. Any imaging modality may be used (e.g., MRI, PET, external views showing posture or skin). Any anatomical structure can be viewed, including skeletal feature and soft tissue features. The comparisons 130, 140 can be between multiple historical instances in order to teach the progression of a malady, such as x-rays of a hip taken at different years 150, 152. FIG. 3 shows an example of two personalized images 130, 140 showing one exemplary patient's history 150, 152. The layout can be personalized depending on, for example, how many images will be included or the amount of text information to be added. The length of the inserted section can also be personalized depending on, for example, the corresponding audio file that explains the symptoms or the condition.

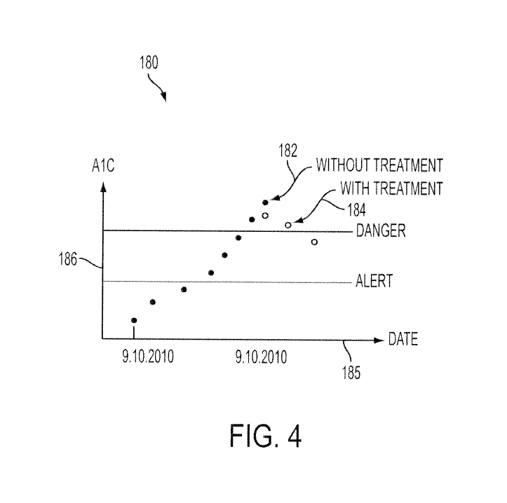

Graphics, such as arrows and circles 118, 132, 142 can be used to highlight a person specific feature within a standard or personalized image. Graphs (FIG. 4) can be included to teach the progression of a malady, such as weight, range of motion, tumor size, etc. as it evolves over time Instructive text, such as a bulleted list of key points or annotations to an image, graph or video can be included.

FIG. 4 shows another example of a personalized patient's medical history 180 displaying a trend 185 of a vital sign (i.e. A1C level) 186 as it would be without treatment 182 compared to the levels with treatment 184.

One example of a GUI outline 200 is displayed in FIG. 5. Each field can be associated with a pull-down menu. For example, under the stock video 210, the first pull-down menu can contain body parts such as hip, arm, etc. and the second pull-down menu can contain files only related to hip or arm. In the inserted fields, the patient ID and name 205 that are obtained can then be used to construct the pull-down menu with, for example file names only related to the patient. Alternatively, the information can be gathered through a query based input medical video story or record. The gathered information can include the following (the list is not all inclusive):
1) Date 206:
2) Patient ID 207:
3) Patient Name 205:
4) Specify stock video name in sequence 210:
5) To be inserted image file name (in sequence, e.g. before, after) 215:
6) Descriptive text to be inserted 216, 217:
7) To be inserted audio file name (in sequence) 220:
8) To be inserted video file name (in sequence) 225 and/or,
9) Specify range of motion (degree) 230.

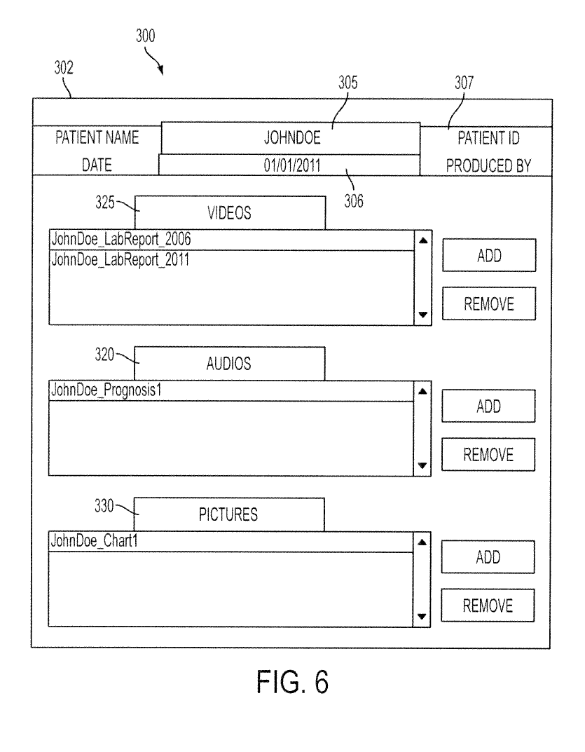

FIGS. 5 and 6 provide examples of GUI screens 202, 302 that prompt a user to select certain elements for adding and/or editing (i.e. a menu of options). The GUI also organizes the personalized medical record and all associated and attached information. For example, FIG. 6 lists an electronic medical record 300 by the type of media, namely, videos 325, audios 320, and pictures 330. The medical record further includes patient name 305, date 306, and patient ID 307. The GUI allows the user to add or remove media from the medical record(s) 100, 200, 300 and to maintain a listing of all media files within the medical record(s) 100, 200, 300.

Certain conditions, for example, such as liver problems and skin problems, can be observed as graininess or texture within an image. The images can be provided that show personalized textural differences. For example, and image of skin or the liver with a standard texture can be shown possibly with a visual enhancement of the texture through some means such as edge enhancement. A personalized image can be shown with the same visual enhancement to enable easy comparison to a standard or to an historical state of a particular malady.

Besides still images and text information, a section of video can be inserted or overlaid to the stock video as well. For example, a video sequence from an exam (e.g. ultrasound 225, 325) that shows a specific condition that is to be addressed by a personalized subsequent treatment.

The personalized medical information can include vital signs and information selected from the group consisting of x-rays, blood tests, blood pressure, pulse rate, respiration rate, temperature, weight, height, BMI index, oxygen levels, urine samples, fecal samples, EKGs, cholesterol levels, blood sugar levels, and medical professionals' notes. Some of these vital signs will be general and included in all medical records while other will be customized relative to a particular's patient's ailments. For example, a diabetic patient may have vital signs for the following: fasting blood glucose, A1C (glycohemoglobin), microalbumin/creatinine, HDL/LDL cholesterol, triglycerides, lipid profile, urinalysis for glucose/protein/ketones, insulin, and C-peptide, et al. The personalized medical record 100, 200, 300 can thus include vital signs pulled from the patient's history wherein not all of the same vital signs are tracked for every patient. For illustration, FIG. 4 displays historical information of A1C data 186 that can be inserted into the video media component 225, 325 along with a doctor's audio file 220, 320 which can be used to explain vital signs and other data present in the medical record.

Electronic files can be created using a combination of stock video, personal information, and standard video editing tools. Additionally, one alternative method provides a mechanism where one or more stock videos and personal information can be assembled automatically. The method includes use of a GUI that allows specification of various parameters (e.g., range of motion), specification of graphics and various patient information. It also can indicate insertion or modification points in the electronic file. As such, the two methods for creating the electronic file includes: (1) video editing software and, (2) automated assembly.

In one exemplary arrangement, the medical record 100, 200, 300 with non-personalizable portions is made available on an electronic medium such as a tape, flash drive, server, electronic file, et. al., prior to the personalization process. The medical record can include a combination of stock video, personal information, and standard video editing tools. An edit list can also prepared for each record, enabling an apparatus to accurately and efficiently advance to each personalizable segment through the use of associated time codes. During personalization, the video is played, preferably using a fast transport mode, to each of the personalizable segments using the time codes. Once the personalizable segment has been reached the contents of segment can be made available as a digital sequence within computer, with the image introduced into the area using a template. The sequence and image, along with other optional personalization elements, including sound, narration, dialog, and so forth, are recorded onto the file until the end of the personalizable segment is reached, at which time the file is again advanced to the next personalizable segment, at which point a process identical to that just described is performed, the combination of the non-personalizable portions in conjunction with the personalizable segments, once completed, forming a final, personalized medical record product.

In addition to image, video, text, graphic insertion or overlays, audio files can be replaced or inserted to further personalize the video. One example of an audio file is reading the information on the slide for patients that choose to have it read. It could also be input as text, as spoken segments specifically for the video, or it could include audio recordings of conversations or sessions such as a radiologist speaking, i.e. doctor notes, on their findings regarding the particular image.

The personalized medical record/video can be constructed by one of several methods. A manual-level practitioner could write a script that uses a video scripting language, such as AVISynth. The script can be automatically generated using information from the GUI (variables). Running the script can play the video. Another manual creating method can directly edit the video using video editing software, such as Adobe After Effects.

In a more user-friendly system a video script for consumption by a video rendering system can be generated automatically using a interface program. The interface program would create a unique script by combining the user specific information parsed from a GUI presented to the user with a base or template script. The interface program would use information from the GUI input to set a collection of pre-defined variables or parameters of the application as well as generate user-specific code for including or excluding particular sections or effects. One method for setting the variables needed by the user created script is to generate a separate file that simply contains variable assignment statements written in the video scripting language. This file is then incorporated into the user created script using an import/include type command.

The information from the GUI can be converted to parameters (e.g. location of the insertion or overlay, length of the insertion or overlay, appearance of the insertion or overlay) used by AVISynth, for example, to assemble the script that produces the personalized medical record/video 100, 200, 300. The personalized medical record/video can then be sent to patients or other parties who have been granted permission and access to view the information either through means such as a web link to a hosting website, email, or hardcopy DVDs. It can also become a component in a patient's electronic medical record. Potential uses of the electronic medical record can be to inform or remind a patient, family member, health care practitioner, or healthcare student, about recommendations 350, an upcoming procedure (e.g., operation), a course of therapy 360, nature of a condition and its potential progression, dietary and other lifestyle factors associated with a condition, payment and paperwork processing (refer to FIG. 7).

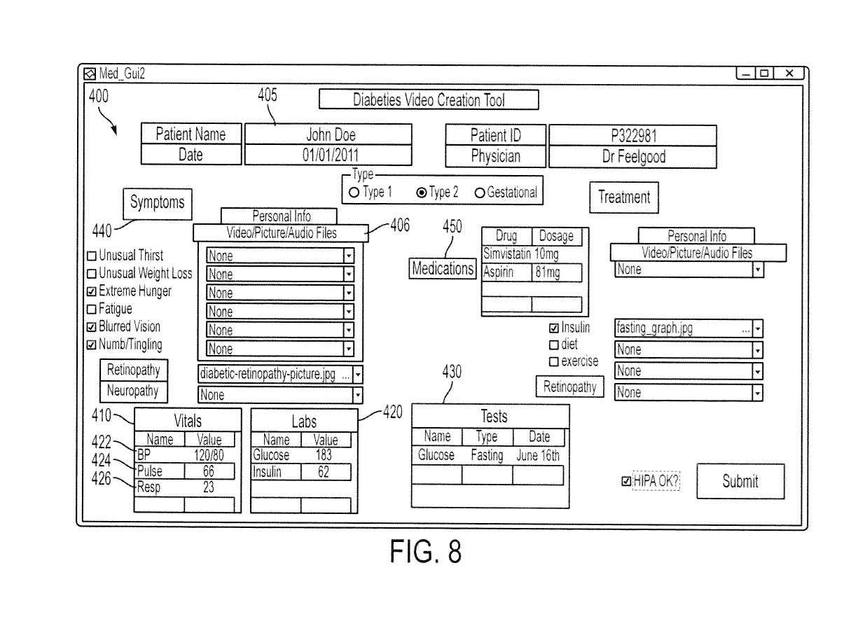

In another arrangement, the method of producing a personalized medical record can comprise: incorporating at least a portion of a prerecorded stock tutorial video having stock information and one or more uncompleted segments for inserting personalized medical information onto a single recording medium. The personalized medical information can include personalized health information including vital health statistics. The method can further comprise combining the at least a portion of the prerecorded stock tutorial video including the stock information on a variety of medical maladies with the personalized medical information. The stock tutorial video can include at least one predeterminable insertion point within the uncompleted segments for inserting the personalized medical information. The method still further comprises providing the personalized medical information at the at least one predeterminable insertion point for merging with the at least a portion of the prerecorded stock tutorial video for producing at least a portion of the personalized medical record. Providing the personalized medical information can include providing a sequence of information selected from the group consisting of a recording of a discussion with a health practitioner, inserting components from a video scripting language, and inserting graphical and textural image annotations. Providing the personalized medical information is selected using a graphical user interface (GUI) for inserting information selected from the group consisting of personalized audio, video, pictorial, and textual data. The textural image annotations can include visual enhancements to compare the personalized medical information with a standard texture. The textural image annotations can include visual enhancements to compare the personalized medical information with an historical texture for teaching a progression of a malady. The graphical image annotations can include highlights selected from the group consisting of text, arrows, and circles for highlighting a person's specific feature within the personalized medical record. Providing the personalized medical information can further include providing a video sequence of information from an exam for showing a specific condition for a subsequent treatment. Providing the personalized medical information can further include providing personalized audio. Providing the personalized medical information can further include providing medical images using a modality selected from the group consisting of an MRI, a PET, an external view of skin, and an external view of posture. The method can further include preparing an edit list associated with the stock tutorial video for use in locating the at least one predeterminable insertion point. Referring to FIG. 8, the personalized medical information 400 can include information selected from the group consisting of patient identification 405, parameterized information 406, historical sequence of information, trend of information, current states, comparison of normal states to the current states, and instructions for therapy. The personalized medical information 400 can include vital signs 410 and information selected from the group consisting of x-rays, blood tests 420, blood pressure 422, pulse rate 424, respiration rate 426, temperature, weight, height, BMI index, oxygen levels, urine samples, fecal samples, EKGs, cholesterol levels, blood sugar levels 420, test results 430, symptoms 440, medications 450, and medical professionals' notes. The personalized medical information can include diseases and information regarding a specific chronic malady, wherein the specific chronic malady is selected from the group consisting of diabetes (FIG. 8), cancer, high blood pressure, respiratory disease, heart disease, high cholesterol, mental illness, depression, and obesity.

Additional uses of the medical record/video can include secondary viewing parties, such as insurance payers, second opinion healthcare practitioners, and/or as a legal record of information given to a patient. The medical record/video can be viewed before meeting with a practitioner to save practitioner's time and maximize visit discussion and outcomes. The medical record/video can also be viewed after a meeting as a reminder or to allow deeper understanding and study, or to inform others what may not have been present.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method of producing a personalized medical record, comprising:
incorporating at least a portion of a prerecorded stock tutorial video having stock information and one or more uncompleted segments for inserting personalized medical information onto a single recording medium;
said personalized medical information includes personalized health information including vital health statistics;
combining said at least a portion of said prerecorded stock tutorial video including said stock information on a variety of medical maladies with said personalized medical information;
said stock tutorial video includes at least one predeterminable insertion point within said uncompleted segments for inserting said personalized medical information; and,
providing said personalized medical information at said at least one predeterminable insertion point for merging with said at least a portion of said prerecorded stock tutorial video for producing at least a portion of the personalized medical record.

2. The method of claim 1, wherein providing said personalized medical information includes:
providing a sequence of information selected from the group consisting of a recording of a discussion with a health practitioner, inserting components from a video scripting language, and inserting graphical and textural image annotations.

3. The method of claim 2, wherein said providing said personalized medical information is selected using a graphical user interface (GUI) for inserting information selected from the group consisting of personalized audio, video, pictorial, and textual data.

4. The method of claim 2, wherein said textural image annotations include visual enhancements to compare said personalized medical information with a standard texture.

5. The method of claim 2, wherein said textural image annotations include visual enhancements to compare said personalized medical information with an historical texture for teaching a progression of a malady.

6. The method of claim 2, wherein said graphical image annotations include highlights selected from the group consisting of text, arrows, and circles for highlighting a person's specific feature within the personalized medical record.

7. The method of claim 1, wherein providing said personalized medical information further includes:
providing a video sequence of information from an exam for showing a specific condition for a subsequent treatment.

8. The method of claim 1, wherein said providing said personalized medical information further includes:
providing personalized audio.

9. The method of claim 1, wherein said providing said personalized medical information further includes:
providing medical images using a modality selected from the group consisting of an MRI, a PET, an external view of skin, and an external view of posture.

10. The method of claim 1, further including preparing an edit list associated with said stock tutorial video for use in locating said at least one predeterminable insertion point.

11. The method of claim 1, wherein said personalized medical information includes information selected from the group consisting of patient identification, parameterized information, historical sequence of information, trend of information, current states, comparison of normal states to said current states, and instructions for therapy.

12. The method of claim 1, wherein said personalized medical information includes vital signs and information selected from the group consisting of x-rays, blood tests, blood pressure, pulse rate, respiration rate, temperature, weight, height, BMI index, oxygen levels, urine samples, fecal samples, EKGs, cholesterol levels, blood sugar levels, and medical professionals' notes.

13. The method of claim 1, wherein said personalized medical information includes diseases and information regarding a specific chronic malady, wherein the specific chronic malady is selected from the group consisting of diabetes, cancer, high blood pressure, respiratory disease, heart disease, high cholesterol, mental illness, depression, and obesity.

14. A method of producing a personalized medical record, comprising:
incorporating at least a portion of a prerecorded stock tutorial video having stock information and one or more uncompleted segments for inserting personalized medical information onto a single recording medium;
combining said at least a portion of said prerecorded stock tutorial video including said stock information on a variety of medical maladies with said personalized medical information;
said stock tutorial video includes at least one predeterminable insertion point within said uncompleted segments for inserting said personalized medical information;
providing said personalized medical information at said at least one predeterminable insertion point for merging with the personalized medical record;
wherein providing said personalized medical information includes providing a sequence of information selected from the group consisting of a recording of a discussion with a health practitioner, inserting components from a video scripting language, and inserting graphical and textural image annotations; and,
said providing said personalized medical information is selected using a graphical user interface (GUI) for inserting information selected from the group consisting of personalized audio, video, pictorial, and textual data.

15. The method of claim 14, wherein said personalized medical information includes information selected from the group consisting of patient identification, parameterized information, historical sequence of images, comparison of normal or previous states, and instructions for therapy;

16. The method of claim 14, wherein said textural image annotations include visual enhancements to compare said personalized medical information with a standard texture.

17. The method of claim 14, wherein said textural image annotations include visual enhancements to compare said personalized medical information with an historical texture for teaching a progression of a malady.

18. The method of claim 14, wherein said graphical image annotations include highlights selected from the group consisting of text, arrows, and circles for highlighting a person's specific feature within the personalized medical record.

19. The method of claim 14, wherein providing said personalized medical information further includes providing a video sequence of information from an exam for showing a specific condition for a subsequent treatment.

20. The method of claim 14, wherein providing said personalized medical information further includes providing personalized audio.

21. The method of claim 14, wherein providing said personalized medical information further includes providing medical images using a modality selected from the group consisting of an MRI, a PET, an external view of skin, and an external view of posture.

22. The method of claim 14, further including preparing an edit list associated with said stock tutorial video for use in locating said at least one predeterminable insertion point.

23. The method of claim 14, wherein said personalized medical information includes information selected from the group consisting of patient identification, parameterized information, historical sequence of information, trend of information, current states, comparison of normal states to said current states, and instructions for therapy.

24. The method of claim 14, wherein said personalized medical information includes vital signs and information selected from the group consisting of x-rays, blood tests, blood pressure, pulse rate, respiration rate, temperature, weight, height, BMI index, oxygen levels, urine samples, fecal samples, EKGs, cholesterol levels, blood sugar levels, and medical professionals' notes.

25. The method of claim 14, wherein said personalized medical information includes diseases and information regarding a specific chronic malady, wherein the specific chronic malady is selected from the group consisting of diabetes, cancer, high blood pressure, respiratory disease, heart disease, high cholesterol, mental illness, depression, and obesity.
